(19) United States
(12) Patent Application Publication
(10) Pub. No.: US 2020/0408022 A1
(43) Pub. Date: Dec. 31, 2020

(54) GATE ACTUATOR ASSEMBLY WITH ALIGNMENT ADJUSTMENT MECHANISM

(71) Applicant: Hy-Security Gate, Inc., Kent, WA (US)

(72) Inventors: Connor Elder, Enumclaw, WA (US); Steven A. Carlsen, Kent, WA (US)

(21) Appl. No.: 16/457,749

(22) Filed: Jun. 28, 2019

(51) Int. Cl. E05F 15/54; F15B 15/06

(52) U.S. Cl. CPC E05F 15/54; E05Y 2600/622; E05Y 2900/40; F15B 15/068

(57) ABSTRACT

The present technology generally provides swing gate actuator assemblies. In particular, some embodiments of the present technology provide a fastener configured to secure an arm of the actuator assembly to a swing gate panel. The fastener can be configured to permit a longitudinal axis of the arm to pivot about a pivot portion on the fastener, thereby reducing the likelihood of gate malfunction in response to a misalignment event.

### TECHNICAL FIELD

The present technology relates generally to gate assemblies, and in particular to gate assembly actuators with an alignment adjustment mechanism.

### BACKGROUND

Gate assemblies are used for a variety of applications, such as preventing unauthorized access to private property and/or establishing a secure facility. The swing gate is a type of gate assembly popular for its simplicity and functionality. Swing gates operate by having a swing gate panel pivotably coupled to a stationary anchor. A swing gate operator, such as a linear actuator, can drive the swing gate between closed and open positions by causing one end of the swing gate panel to pivot about a stationary anchor. However, if the swing gate panel and the actuator assembly are not properly aligned, undesirable twisting or bending loads on the swing gate panel or the actuator can be generated during actuation of the swing gate.

### SUMMARY

The present technology provides a swing gate actuator assembly for use with a swing gate. Some embodiments of the swing gate actuator assembly include a motor and an arm coupled to the motor. The arm can have a distal portion spaced apart from the motor and coupleable to the swing gate. The distal portion can include a channel extending therethrough. The actuator assembly can also include a fastener insertable through the channel and configured to secure the arm to the swing gate. The fastener can include a shaft having opposing first and second end portions and an arm engagement region between the first and second end portions. The arm engagement region is configured to reside at least partially within the channel. The arm engagement region can include first and second tapered sections extending in opposite directions. The first tapered section extends axially in a first direction toward the first end portion of the shaft, and the second tapered section extends axially in a second direction opposite the first direction and toward the second end portion of the shaft. A pivot portion is positioned between the first and second tapered sections. The first and the second tapered sections can have variable diameters extending along their axial lengths, and the pivot portion can have a diameter greater than the variable diameters of the first and second tapered sections. Thus, the pivot portion can be configured to engage the distal portion of the arm within the channel, and the first and second tapered sections can be configured to allow a longitudinal axis of the fastener to pivot within the channel about the pivot portion.

Some embodiments of the present technology provide a swing gate actuator assembly configured to open and close a swing gate. The swing gate actuator assembly comprises a motor configured to move the swing gate between open and closed positions, and an arm configured to connect the motor and the swing gate. The arm includes a proximal portion adjacent the motor and a distal portion spaced apart from the motor. The distal portion includes an interior surface defining a channel extending radially through the distal portion. A fastener can be inserted through the channel and configured to secure the arm to the swing gate. The fastener can include an arm engagement region extending along an axial length of the fastener. The arm engagement region can be configured to reside at least partially within the channel and can include a first section having a first cross-section with a first diameter and a second section having a second cross-section with a second diameter, wherein the second diameter is less than the first diameter. When the arm is secured to the swing gate by the fastener, the interior surface of the channel can contact the arm engagement region at the first section and can be spaced apart from the arm engagement region at least at a portion of the second section. The arm engagement region can thus be configured to allow a longitudinal axis of the arm to pivot relative to the swing gate about the first section.

Some embodiments of the present technology provide a swing gate actuator assembly that comprises a motor and an arm operably couplable to the motor. The arm includes a proximal portion configured to be adjacent to the motor and a distal portion configured to be spaced apart from the motor. The distal portion includes a channel extending radially therethrough. A fastener can be insertable through the channel and configured to secure the arm to the swing gate. The fastener can include a shaft having an arm engagement region configured to reside at least partially within the channel. The arm engagement region can include a first tapered section extending axially along a first portion of the shaft, a second tapered section extending axially along a second portion of the shaft, and a pivot portion positioned between the first tapered section and the second tapered section. The first and second tapered sections can have variable diameters extending along their axial lengths, and the pivot portion can have a diameter greater than the variable diameters of the first and second tapered sections.

### BRIEF DESCRIPTION OF THE DRAWINGS

FIG. 1 is an isometric view of a swing gate assembly configured in accordance with select embodiments of the present technology.

FIG. 2 is an isometric view of the swing gate assembly of FIG. 1 and depicts the swing gate assembly in a partially open position.

FIG. 3 is an enlarged front view of a portion of the swing gate assembly shown in FIG. 1 and depicts a connection between an actuator assembly and a swing gate panel.

FIG. 4 is an isometric view of the portion of the swing gate assembly shown in FIG. 3.

FIG. 5 is a front view of a swing gate assembly operating with an object obstructing its swing path.

FIG. 6 is an isometric view of a fastener configured in accordance with select embodiments of the present technology.

FIG. 7 is a front view of a connection between an actuator assembly and a swing gate panel and illustrates the connection in a first state.

FIG. 8 is a front view of the connection between the actuator assembly and the swing gate panel shown in FIG. 7 and illustrates the connection in a second state.

FIG. 9 is a cross-sectional view of the connection between the actuator assembly and the swing gate panel shown in FIG. 7.

FIG. 10 is a cross-sectional view of a connection between an actuator assembly and a swing gate panel configured in accordance with select embodiments of the present technology.

### DETAILED DESCRIPTION

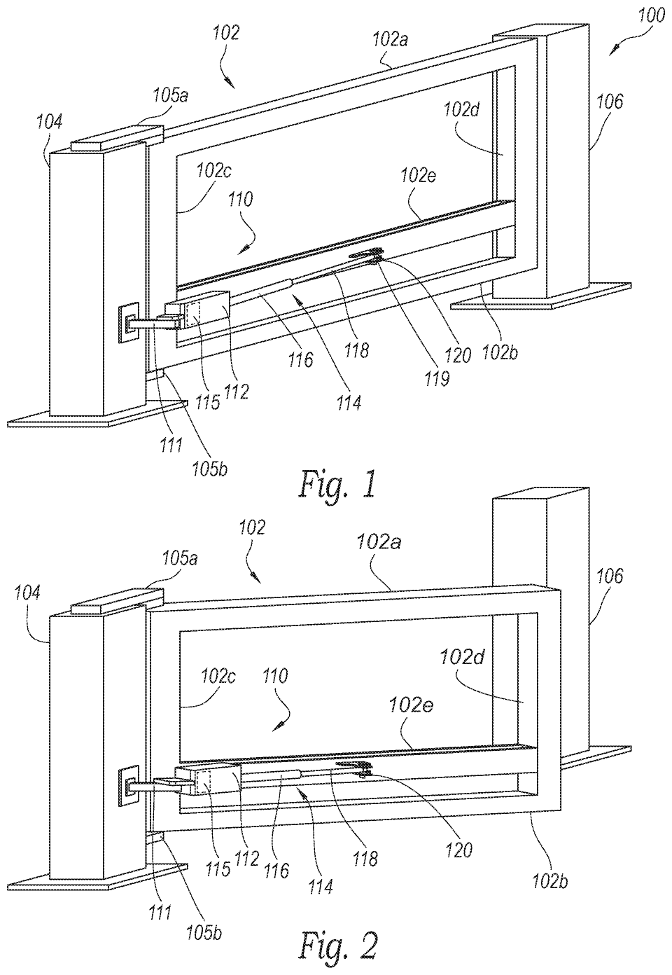

Swing gate systems, associated drive systems, and related methods are described in detail herein in accordance with embodiments of the present disclosure. The systems and associated assemblies and/or features overcome drawbacks experienced in the prior art and provide other benefits. Certain details are set forth in the following description and in FIGS. 1-10 to provide a thorough and enabling description of various embodiments of the disclosure. Other details describing well-known structures and components often associated with gate assemblies and associated with forming such assemblies, however, are not set forth below to avoid unnecessarily obscuring the description of various embodiments of the disclosure. Many of the details, dimensions, angles, relative sizes of components, and/or other features shown in the Figures are merely illustrative of particular embodiments of the disclosure. Accordingly, other embodiments can have other details, dimensions, angles, sizes, and/or features without departing from the spirit and scope of the present disclosure. In addition, further embodiments of the disclosure may be practiced without several of the details described below while still other embodiments of the disclosure may be practiced with additional details and/or features. In the Figures, identical reference numbers identify identical, or at least generally similar, elements. Moreover, one of ordinary skill in the art will appreciate that any relative positional terms such as above, below, over, under, etc., do not necessarily require a specific orientation of the assemblies as described herein. Rather, these or similar terms are intended to describe the relative position of various features of the disclosure described herein.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

Where applicable, relative terminology such as “about” or “substantially” is used herein as meaning the stated value plus or minus ten percent. References throughout the specification to “one embodiment” or “an embodiment” means that a particular feature, structure, or characteristic described in connection with the embodiment and included in at least one embodiment of the present invention. Thus, the appearances of the phrase “in one embodiment” or “in an embodiment” in various places through the specification are not necessarily all referring to the same embodiments. Furthermore, the particular features, structures, or characteristics may be combined in any suitable manner in one or more embodiments.

FIGS. 1 and 2 are angled top-down views of an example swing gate assembly 100 in which aspects of gate actuator assembly with alignment adjustment mechanism can be implemented. The example swing gate assembly 100 shown in FIGS. 1 and 2 illustrate the swing gate assembly 100 in a closed position and a partially open position, respectively. The swing gate assembly 100 can include a swing gate panel 102, a first anchor 104, and an actuator assembly 110. The swing gate panel 102 can couple to the first anchor 104 via a first connection member 105a (e.g., an upper connection member) and/or via a second connection member 105b (e.g., a lower connection member) (collectively referred to as “connection members 105”). As will be appreciated by one of skill in the art, the swing gate panel 102 may be coupled to the first anchor 104 via other suitable structure that enables the swing gate panel 102 to remain coupled to the first anchor 104 and pivotally movable through a plurality of positions between open and closed positions. Optionally, the swing gate assembly 100 may further include a second anchor 106 spaced apart from the first anchor 104 by approximately a length of the swing gate panel 102. The second anchor 106 is laterally aligned with the first anchor 104. Accordingly, when the swing gate is in the closed position, the swing gate panel 102 generally extends between the first anchor 104 and second anchor 106. For example, if the swing gate panel 102 is positioned such that it substantially blocks a road, the first anchor 104 may be positioned on a first side of the road, and the second anchor 106 may be positioned on a second side of the road opposite the first side.

As shown in FIG. 1, the swing gate panel 102 can have a generally rectangular shape that comprises opposing upper and lower horizontal portions 102a and 102b extending between opposing proximal vertical portion 102c and distal vertical portion 102d (collectively referred to as the “portions 102a-d”). The portions 102a-d collectively define the outer perimeter of the swing gate panel 102. The portions 102a-d may be individual panels coupled together to form swing gate panel 102 (e.g., via welding, securing elements, or other methods). Alternatively, the swing gate panel 102 may be integrally manufactured such that the portions 102a-d are a unitary structure. As further shown in FIG. 1, the swing gate panel 102 may also include an intermediate portion 102e positioned between the proximal vertical portion 102c and distal vertical portion 102d. The swing gate panel 102 illustrated in FIG. 1 is one of many potential configurations that the swing gate panel 102 may take while still remaining within the scope of the present technology. For example, the swing gate panel 102 may be a generally solid rectangular slab or any other shape that provides a barrier.

The first anchor 104 and the second anchor 106 shown in FIGS. 1 and 2 are substantially vertical posts, although other anchors can be used with the swing gate panel 102. As illustrated in FIGS. 1 and 2, the proximal vertical portion 102c of the swing gate panel 102 is pivotally coupled to the first anchor 104, such that the distal portion 102d swings through an arc when the gate panel 102 moves between the closed and opened positions.

The swing gate 102 can move between the closed and open positions upon activation of the actuator assembly 110. As illustrated in FIGS. 1 and 2, the actuator assembly 110 comprises a linear actuator that can attach to the first anchor 104 or pivotably couple to the first anchor 104 via a bracket 111. The linear actuator 110 is pivotally attached at a distal end to the gate panel 102, such as at the intermediate portion near a mid-portion of the gate panel. The actuator assembly 110 can drive the swing gate panel through a plurality of positions between the closed position (e.g., FIG. 1) and the open position. FIG. 2 illustrates an intermediate position between the open and the closed positions.

The illustrated actuator assembly 110 shown in FIGS. 1 and 2 includes an actuator housing 112 and an arm 114. The actuator housing 112 contains a motor 115 that can be activated to extend or retract the arm, thereby closing and opening the swing gate panel 102. The actuator housing 112 may be secured to the same anchor to which the swing gate panel 102 assembly is secured (e.g., the first anchor 104). The actuator housing 112 is spaced apart from the anchor 104, which creates an angle between a plane of the swing gate panel 102 and a longitudinal axis of the arm 114 when in the fully closed position. This can help facilitate opening and closing the gate panel.

The arm 114 includes a proximal arm portion 116 adjacent to the actuator housing 112 and a distal arm portion 118 spaced apart from the actuator housing. A distal end region 119 of the distal arm portion 118 may be coupled to the swing gate panel 102. For example, as illustrated in FIGS. 1 and 2 the distal end region 119 of the distal arm portion 118 is secured to the horizontal intermediate portion 102e via an attachment bracket 120 affixed to the gate panel 102. However, in other embodiments, the distal arm portion 118 may be directly secured or otherwise coupled to the swing gate panel 102 at another suitable position via fasteners or other attachment mechanisms. To facilitate attachment to the swing gate panel 102 via the attachment bracket 120, the distal end region 119 of the distal arm portion 118 may have a channel 122 extending therethrough, so the longitudinal axis of the channel 122 is substantially perpendicular to a longitudinal axis of the distal arm portion 118. The channel 122 and the attachment bracket 120 can be configured to receive a fastener 130 to facilitate coupling the distal end of the arm 114 to the attachment bracket 120 on the swing gate panel 102.

The actuator assembly 110 of the illustrated embodiment shown in FIGS. 1 and 2 can be a hydraulic actuator or other linear actuator, and the proximal arm portion 116 includes a tubular body that slidably receives a segment of the distal arm portion 118 as the actuator assembly 110 is activated, thereby extending or retracting the distal arm portion 118 relative to the proximal arm portion 116. For example, the motor 115 contained within the actuator housing 112 can drive a segment of the distal arm portion 118 into the proximal arm portion 116 to retract the arm 114, thereby pulling on the swing gate panel 102 and moving it toward the open position (e.g., moving from the configuration of FIG. 1 to the configuration of FIG. 2). To close the gate, the motor 115 can drive a portion of the distal arm portion 118 out of the proximal arm portion 116, thereby extending the arm 114 and pushing on the swing gate panel 102 to move it toward the closed position (e.g., moving from the configuration of FIG. 2 to the configuration of FIG. 1).

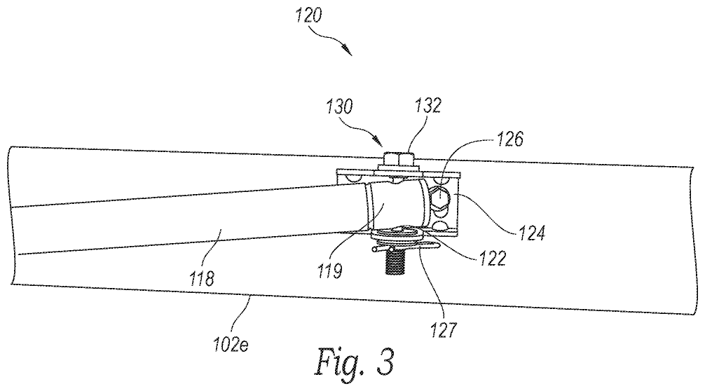

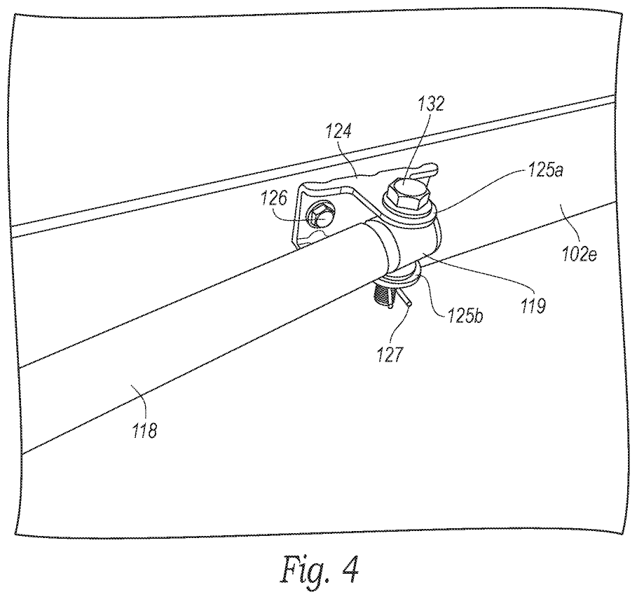

FIGS. 3 and 4 are enlarged views of the distal arm portion 118 and the attachment bracket 120 shown in FIGS. 1 and 2. As illustrated in FIG. 3, the attachment bracket 120 includes a web portion 124 that can securely connect to the swing gate panel 102 via one or more fasteners or other securing elements 126. In some embodiments, the web portion 124 of the attachment bracket 120 can be coupled to the swing gate panel 102 via a welding or other securing process, such that the bracket 120 is integral with the swing gate panel 120. As illustrated in FIG. 4, the attachment bracket 120 also includes a first projection 125a and a second projection 125b (collectively referred to as “projections 125”) that are spaced apart from one another and extend away from the web portion 124, so as to define a receiving area between the projections 125. The projections 125 can have axially aligned apertures sized and positioned to receive a fastener 130. The projections 125 may be spaced apart by a distance greater than a diameter of the distal end region 119 of the distal arm portion 118. Accordingly, the distal end region 119 is positioned between the projections 125 with the channel 122 aligned with the apertures, so the fastener 130 can extend through the apertures in the projections and through the channel 122, thereby affixing the distal arm portion 118 to the swing gate panel 102 via the attachment bracket 120.

As shown in FIG. 3, the channel 122 includes a cylindrical interior surface defining a generally tubular volume. A portion of the fastener 130 can reside within the tubular volume of the channel 122 when the arm 114 is secured to the swing gate panel 102. In some embodiments, at least a portion of the fastener 130 contacts at least a portion of the cylindrical interior surface when the distal arm portion 118 is secured to the swing gate panel 102. The fastener 130 can also be configured to permit a space to exist between at least a portion of the interior surface of the channel 122 and at least a portion of the fastener 130 positioned within the channel 122 when the arm 114 is secured to the swing gate panel 102 to allow for slight pivoting motion to accommodate potential misalignment within the swing gate assembly 100.

To connect the arm 114 and the swing gate panel 102, the distal end region 119 can be positioned between the projections 125 such that the channel 122 aligns with the first and second apertures of the projections 125. The fastener 130 can then be inserted through the apertures in the projections 125 and through the channel 122, thereby releasably securing the distal arm portion 118 to the swing gate panel 102. In some embodiments, the fastener 130 can be releasably secured to the bracket 120. For example, as shown in FIG. 3, a cotter pin 127 can be used to releasably secure the fastener 130 in position with the bracket 120, and the distal end region 119 between the cotter pin 127 and an enlarged head 132 of the fastener 130. Other embodiments can use one or more nuts threadably attached to the end of the fastener 130 to capture the bracket 120 and the distal end region 119 between the fastener's head 132 and the threaded nuts. In additional alternative embodiments, the fastener 130 does not have the enlarged head 132 and is secured into position using a second cotter pin, an e-clip, or other securing element.

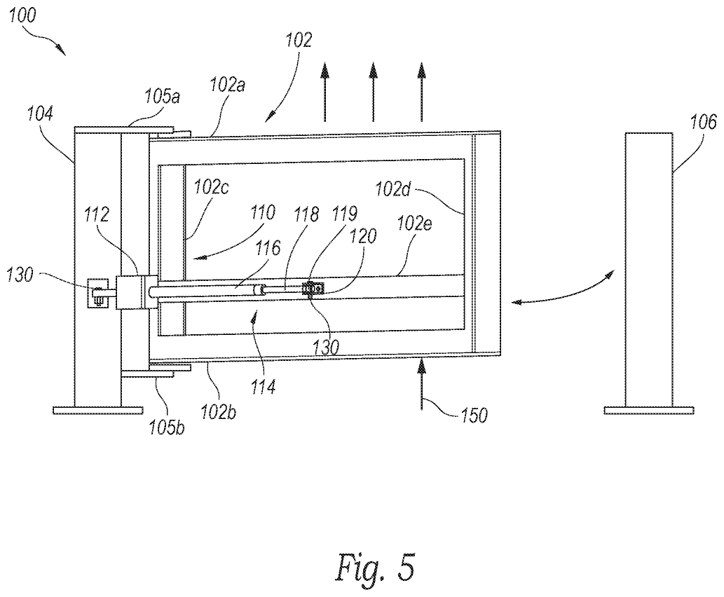

The swing gate panel 102 of the illustrated embodiment is configured to swing through an arc and with a range of motion approximately 0 degrees-150 degrees, although other ranges can be used. A swing gate can bind or create undesirable twisting loads as it swings through its range of motion if the arrangement between the anchor 104, the swing gate panel 102, and/or the actuator assembly 110 is misaligned, or if upward or downward loads are applied to the swing gate panel 102. For example, when the swing gate assembly 100 is accurately installed, the anchors 104 and 106, and the vertical portion 102c of swing gate panel 102, and the longitudinal axis of the fastener 130 should all be parallel to the Z-Axis, which preferably corresponds to vertical alignment. In addition, the longitudinal axis of the actuator assembly 110 is to remain parallel to the X-Y plane throughout the arcuate travel of the swing gate panel 102 between the closed and open positions. A misalignment event is anything that could potentially cause the vertical portion 102c or the longitudinal axis of the fastener 130 to come out of parallel with the Z-axis, or that causes the longitudinal axis of the actuator assembly 110 to come out of parallel with the X-Y plane. Undesirable twisting or binding loads can occur in response to a misalignment event, such as if the anchor 104 is installed out of plumb, or if the plane of the swing gate panel 102 is skewed relative to the anchor 104. Such misalignment can be causes by, as an example, poor installation, inconsistent construction of components, and/or settling of the components over time after installation. A misalignment event and resulting binding or twisting loads can also occur if an impact or other external load 150 (FIG. 5) is applied to the swing gate panel 102, such as during movement between the closed and open positions.

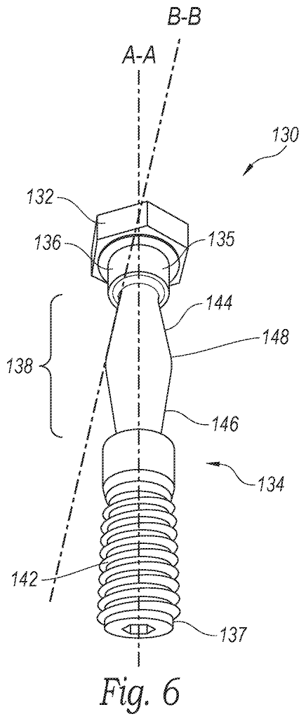

The actuator assembly 110 can be configured to accommodate for some vertical and/or torsional movement of the swing gate panel 102 relative to the anchor 104 (FIG. 1) caused by a misalignment event, so as to avoid excessive binding between the swing gate panel 102 and the actuator assembly 110 during movement between the closed and open positions. In one embodiment illustrated in FIG. 6, the fastener 130 is configured to accommodate for the vertical and/or torsional motion. The fastener 130 of the illustrated embodiment includes a shaft 134 extending from the enlarged head 132. The shaft 134 includes an arm engagement region 138 positioned between proximal end portion 135 and distal end portion 137. In some embodiments, the proximal end portion 135 can have a shoulder 136 adjacent to the enlarged head 132 and extending to the arm engagement region 138. The distal end portion 137 is configured to receive a retaining member, such as a threaded nut, a cotter pin 127 (FIGS. 5 and 6), or other retention member. In the illustrated embodiment, the distal end portion 137 has threads 142, although such threads are not required. The shaft 134 can be sized to extend through the apertures in the upper and lower projections 125 of the attachment bracket 120 and through the channel 122 in the distal end region 119 of the distal arm portion 118 to securely, yet rotatably, connect the actuator arm 114 to the swing gate panel 102. When the fastener 130 is in position as shown in FIGS. 5 and 6, the arm engagement region 138 is positioned within the channel 122 and has a length that substantially corresponds to the length of the channel. Accordingly, in the illustrated embodiment, the proximal and distal end portions 135 and 137 are external of the channel 122 when the fastener is in position.

The arm engagement region 138 has opposing proximal and distal tapered sections 144 and 146 extending away from an intermediate pivot portion 148 configured to engage the cylindrical interior surface defining the channel 122. The proximal tapered section 144 can be shaped and sized such that the diameter of the section decreases as the section extends away from the intermediate pivot portion 148 and toward the shoulder portion 136 adjacent to the enlarged head 132. The distal tapered section 146 tapers in the opposite direction, such that the diameter of the section decreases as the section extends away from the intermediate pivot portion 148 and toward the distal portion 137. In the illustrated embodiment, each of the proximal and distal tapered sections 144 and 146 have the greatest diameter adjacent to the intermediate pivot portion 148. Accordingly, each of the proximal and distal tapered sections 144 and 146 have a frusto-conical shape. The dimensions of the proximal and distal tapered sections 144 and 146 can be the same, although in other embodiments the dimensions (i.e., diameters, length, circumference, and/or tapered angle of the proximal tapered section 144) can be different that those of the distal tapered section. The degree of tapering can also be defined as an angle between a longitudinal axis A-A of the shaft 134 and an axis B-B defined by an outer surface of the respective proximal or distal tapered sections 144 or 146. In the illustrated embodiment, the angle between the central axis A-A and the axis B-B may be in the range of approximately 0.5 degrees-30 degrees, depending upon the desired range of motion of the actuator arm relative to the swing gate panel 102 (FIG. 1). In other embodiments, the angle between the central axis A-A and the axis B-B may be between approximately 0 degrees-90 degrees, although other angles could be used.

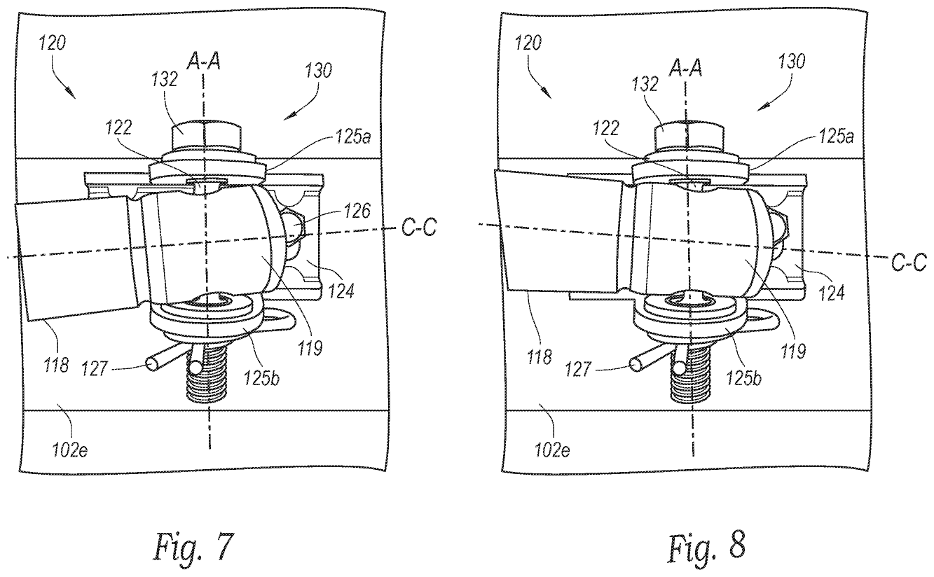

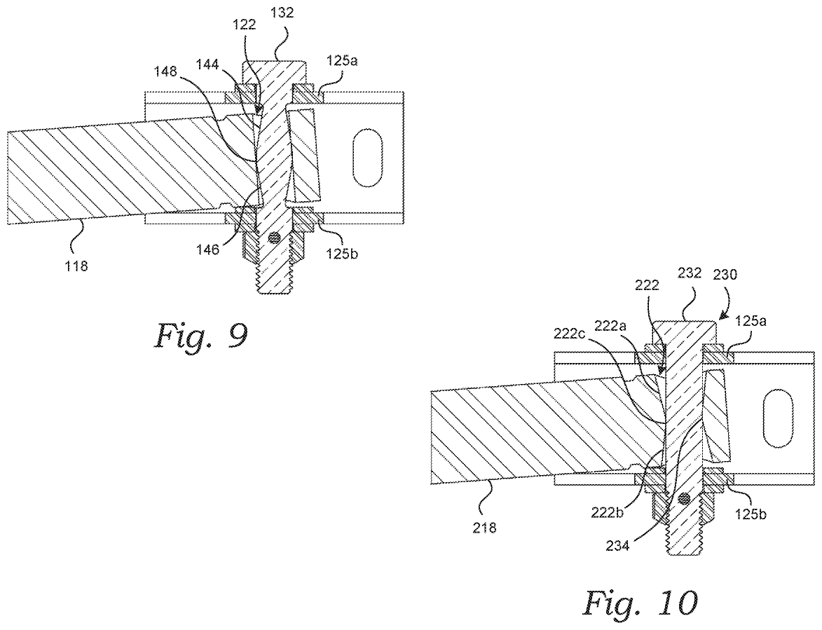

FIGS. 7 and 8 illustrate the fastener 130 shown in FIG. 6 inserted through the apertures of the projections 125 of the bracket 120 and through the channel 122 in the distal end region 119 of the actuator assembly 110. FIG. 9 is a cross-sectional view of the assembly shown in FIGS. 7 and 8. The fastener 130 is shown secured in place relative to the web portion 124 of the bracket 120 via the cotter pin 127. In other embodiments, the fastener 130 can be secured in place via other securing mechanisms or configurations to hold the fastener 130 in position relative to the web portion 124 of the bracket 120. The arm engagement region 138 of the fastener 130 is positioned within the channel 122 of the distal end region 119. Due to the tapered shape of the arm engagement region 138, the intermediate pivot portion 148 engages the interior surface of the channel 122, while at least a portion of the proximal tapered section 144 and/or the distal tapered section 146 within the channel 122 is spaced apart from and does not engage the interior surface of the channel 122, as illustrated in FIG. 9.

For example, when the fastener is substantially perpendicular to a longitudinal axis C-C of the distal arm portion 118, the intermediate pivot portion 148 engages the interior surface of the channel 122 substantially around the circumference of the pivot portion 148, while each of the proximal and distal tapered sections 144 and 146 do not engage the interior surface. In this configuration, as shown in FIG. 7, the actuator arm 114 is properly aligned relative to the swing gate panel 102, and when the actuator assembly 110 is activated to extend or retract the actuator arm 114 to move the swing gate panel 102 between the closed and open positions, the distal end region 119 of the actuator arm will rotate smoothly about the longitudinal axis of the fastener 130.

When the longitudinal axis A-A of the fastener 130 is not substantially perpendicular to the longitudinal axis C-C of the distal arm portion 118, the intermediate pivot portion 148 may engage the interior surface of the channel 122 while at least a portion of the proximal tapered section 144 and/or the distal tapered section 146 remains at least partially spaced apart from the interior surface of the channel 122. This configuration provided by the proximal and distal tapered sections 144 and 146 relative to the intermediate pivot portion 148 allows for a degree of pivotal movement of the swing gate panel 102 relative to the actuator arm 114. For example, this pivotal movement prevents binding if, as discussed above, a misalignment event occurs such that the anchor 104 or the vertical portion 102c of swing gate panel 102 or the longitudinal axis of the fastener 130 comes out of parallel with the Z-Axis, or if the longitudinal axis of the actuator assembly 110 comes out of parallel with the X-Y plane, thereby avoiding excessive torque on the actuator arm 114 during the misalignment event, while still allowing the actuator arm 114 to extend or retract to move the swing gate panel 102 between the open and closed positions without binding. Accordingly, the contoured fastener 130 allows for the arm 114 to pivot to accommodate for a misalignment event while still allowing for smooth operation of the swing gate panel 102 and the actuator assembly 110 for movement between the closed and open positions.

In another embodiment of an adjustment mechanism in accordance with aspects of the present technology, the channel in the distal arm portion that receives the fastener is tapered or otherwise contoured to allow for the pivotal movement of the swing gate panel with respect to the actuator arm in the event of a misalignment event. As illustrated in FIG. 10, the distal arm portion 218 of the actuator assembly has a channel 222 extending therethrough such that the longitudinal axis of the channel 122 is substantially perpendicular to a longitudinal axis of the distal arm portion 118. The channel 122 has a tapered interior surface including a first tapered section 222a, a second tapered section 222b, and an intermediate pivot portion 222c. A fastener 230 having a substantially cylindrical shaft 234 can be inserted through the channel 222 to secure the actuator assembly to the swing gate panel. At least an intermediate portion 234 of the fastener 220 contacts the interior surface of the channel 222 at the intermediate pivot portion 222c. As illustrated, a space exists between at least a portion of the fastener 230 and at least a portion of the interior surface of the channel 222 (e.g., the first tapered section 222a and/or the second tapered section 222b). This configuration provided by the first and second tapered sections 222a and 222b relative to the intermediate pivot portion 222c allows for a degree of pivotal movement of the swing gate panel 102 relative to the actuator arm 114. For example, this pivotal movement prevents binding upon occurrence of a misalignment event, thereby avoiding excessive torque on the actuator arm, while still allowing the actuator arm to extend or retract to smoothly move the swing gate panel 102 between the open and closed positions.

As one of ordinary skill in the art will appreciate from the foregoing, a number of variations of the described embodiments are possible without deviating from the scope of the present disclosure. For example, the arm engagement region 138 can have a variety of configurations other than those explicitly discussed above, while still enabling the swing gate panel to have a range of motion with respect to the actuator arm. For example, instead of having first and second tapered sections, the arm engagement region may have first and second sections that have a substantially constant circumference along their axial lengths. A pivot portion with a circumference greater than the substantially constant circumference of the first and second sections can be positioned between the first and second sections. Other suitable configurations for the arm engagement region include a single tapered section or a single section with a constant circumference less than the circumference of the pivot portion.

The fasteners 130 described herein can also be used to connect the actuator assembly 110 to the anchor 104 (e.g., at the bracket 111) to reduce the likelihood of gate malfunction in response to a misalignment event. In such embodiments, the fastener 130 can releasably secure the actuator assembly 110 to the anchor 104 and enable a range of motion between the actuator assembly 110 and the anchor 104. Thus, in response to a misalignment event, the actuator assembly 110 can pivot about the pivot portion 148 of the fastener 130, reducing the likelihood of gate malfunction. In some embodiments, an actuator assembly can have the fasteners described herein at both its swing gate panel connection and at its anchor connection. In other embodiments, an actuator assembly has the fasteners described herein at either its swing gate panel connection or its anchor connection, but not both.

The fasteners described herein may comprise any material suitable for use with an actuator assembly and may be selected based off one or more desired properties of the fastener. In some embodiments, for example, the material may be selected to ensure the fastener is strong enough to support the weight of the swing gate panel. In some embodiments, the material may be selected to ensure the fastener is at least partially resistant to corrosion or other deterioration. In some embodiments, the material may be selected and/or the fastener may be configured such that the fastener can operate as a sheer point in the swing gate assembly. By acting as a sheer point, the fastener can protect other components of the swing gate assembly from being damaged in response to a critical event. Exemplary materials can include steel, stainless steel, titanium, aluminum, or the like. In some embodiments, the fastener may comprise an alloy such as a combination of one or more of steel, stainless steel, titanium, or the like and one or more common additives known in the art. The fastener can be manufactured according to methods known in the art.

From the foregoing, it will be appreciated that specific embodiments of the invention have been described herein for purposes of illustration, but that various modifications may be made without deviating from the spirit and scope of the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention.

I/We claim:

1. A swing gate actuator assembly for use with a swing gate, comprising:
a motor;
an arm coupled to the motor, the arm having a distal portion spaced apart from the motor and coupleable to the swing gate, wherein the distal portion includes a channel extending therethrough; and
a fastener insertable through the channel and configured to secure the arm to the swing gate, the fastener comprising:
a shaft having opposing first and second end portions and an arm engagement region between the first and second end portions, the arm engagement region configured to reside at least partially within the channel, wherein the arm engagement region includes—
a first tapered section extending axially in a first direction toward the first end portion of the shaft;
a second tapered section extending axially in a second direction opposite the first direction and toward the second end portion of the shaft; and
a pivot portion positioned between the first tapered section and the second tapered section;
wherein the first tapered section and the second tapered section have variable diameters extending along their axial lengths and the pivot portion has a diameter greater than the variable diameters of the first and second tapered sections, and
wherein the pivot portion is configured to engage the distal portion of the arm within the channel, and the first and second tapered sections are configured to allow a longitudinal axis of the fastener to pivot within the channel about the pivot portion.

2. The swing gate actuator assembly of claim 1 wherein the first tapered section has a first end region spaced apart from the pivot portion toward the first end portion and a second end region adjacent the pivot portion, and wherein the diameter of the first tapered section at the first end region is less than the diameter of the first tapered section at the second end region.

3. The swing gate actuator assembly of claim 2 wherein the pivot portion has a diameter substantially the same as the diameter of the second end region.

4. The swing gate actuator assembly of claim 1 wherein the second tapered section has a first end region spaced apart from the pivot portion towards the second portion and a second end region adjacent the pivot portion, and wherein the diameter of the first tapered section at the first end region is less than the diameter of the first tapered section at the second end region.

5. The swing gate actuator assembly of claim 4 wherein the pivot portion has a diameter substantially the same as the diameter of the second end region.

6. The swing gate actuator assembly of claim 1 wherein the channel has a cylindrical interior surface, the pivot portion being in engagement with the interior surface around a circumference of the pivot portion with the first and second tapered sections being out of engagement with the interior surface when the fastener is substantially perpendicular to a longitudinal axis of the distal portion of the arm.

7. The swing gate actuator assembly of claim 1 wherein the fastener further comprises a head and a substantially cylindrical proximal section extending along a portion of the axial length of the fastener, wherein the substantially cylindrical proximal section is positioned between the head and the arm engagement region.

8. The swing gate actuator assembly of claim 1 wherein the fastener further comprises a substantially cylindrical distal section extending along a portion of the axial length of the fastener and positioned between the arm engagement region and the second end portion of the shaft.

9. The swing gate actuator assembly of claim 1 wherein the channel has a cylindrical interior surface, and wherein, when the fastener is inserted through the channel, at least a portion of either the first tapered section or the second tapered section positioned within the channel is spaced apart from the interior surface.

10. The swing gate actuator assembly of claim 9 wherein the arm can pivot about the pivot portion and cause the interior surface to contact the portion of either the first tapered section or the second tapered section positioned within the channel and spaced apart from the interior surface such that an angle between the longitudinal axis of the fastener and a longitudinal axis of the arm is altered.

11. A swing gate actuator assembly configured to open and close a swing gate, the swing gate actuator assembly comprising:
a motor configured to move the swing gate between open and closed positions;
an arm configured to connect the motor and the swing gate, wherein the arm includes a proximal portion adjacent the motor and a distal portion spaced apart from the motor, and wherein the distal portion includes an interior surface defining a channel extending radially through the distal portion; and
a fastener configured to secure the arm to the swing gate, wherein the fastener includes an arm engagement region extending along an axial length of the fastener and configured to reside at least partially within the channel, and wherein the arm engagement region includes—
a first section having a first cross-section with a first diameter, and
a second section having a second cross-section with a second diameter, wherein the second diameter is less than the first diameter;
wherein, when the arm is secured to the swing gate by the fastener, the interior surface of the channel contacts the arm engagement region at the first section and is spaced apart from the arm engagement region at least at a portion of the second section, and wherein the arm engagement region is configured to allow a longitudinal axis of the arm to pivot relative to the swing gate about the first section.

12. The swing gate actuator assembly of claim 11 wherein the second section of the arm engagement region has a length extending longitudinally along a portion of the axial length of the fastener, and wherein the second section has a constant diameter along the length.

13. The swing gate actuator assembly of claim 11 wherein the second section of the arm engagement region has a length extending longitudinally along a portion of the axial length of the fastener, and wherein the second section has a variable diameter along the length.

14. The swing gate actuator assembly of claim 11 wherein the arm engagement region further comprises a third section having a third cross-section with a third diameter less than the first diameter, and wherein the first section is positioned between the second section and the third section along the axial length of the fastener.

15. The swing gate actuator assembly of claim 14 wherein the third section of the arm engagement region has a length extending longitudinally along a portion of the axial length of the fastener, and wherein the third section has a constant diameter along the length.

16. The swing gate actuator assembly of claim 14 wherein the third section of the arm engagement region has a length extending longitudinally along a portion of the axial length of the fastener, and wherein the third section has a variable diameter along the length.

17. The swing gate actuator assembly of claim 11, further comprising a linear actuator coupled to the motor and having a body portion, wherein the arm is a shaft axially extendible relative to the body portion between extended and retracted positions.

18. A swing gate actuator assembly, comprising:
a motor;
an arm operably couplable to the motor, wherein the arm includes a proximal portion configured to be adjacent the motor and a distal portion configured to be spaced apart from the motor, and wherein the distal portion includes a channel extending radially therethrough; and
a fastener insertable through the channel and configured to secure the arm to the swing gate, the fastener comprising:
a shaft having an arm engagement region configured to reside at least partially within the channel, wherein the arm engagement region includes—
a first tapered section extending axially along a first portion of the shaft;
a second tapered section extending axially along a second portion of the shaft; and
a pivot portion positioned between the first tapered section and the second tapered section;
wherein the first tapered section and the second tapered section have variable diameters extending along their axial lengths, and
wherein the pivot portion has a diameter greater than the variable diameters of the first and second tapered sections.

19. The swing gate actuator assembly of claim 18 wherein the first tapered section has a first end region spaced apart from the pivot portion and a second end region adjacent the pivot portion, and wherein the diameter of the first tapered section at the first end region is less than the diameter of the first tapered section at the second end region.

20. The swing gate actuator assembly of claim 18 wherein the second tapered section has a first end region spaced apart from the pivot portion and a second end region adjacent the pivot portion, and wherein the diameter of the first tapered section at the first end region is less than the diameter of the first tapered section at the second end region.

21. A swing gate actuator assembly for use with a swing gate, comprising:
a motor;
an arm coupled to the motor, the arm having a distal portion spaced apart from the motor and coupleable to the swing gate, wherein the distal portion includes a channel extending therethrough, and wherein the channel includes an interior surface; and
a fastener insertable through the channel and configured to secure the arm to the swing gate, the fastener comprising:
a shaft having opposing first and second end portions and an arm engagement region between the first and second end portions, the arm engagement region configured to reside at least partially within the channel;
wherein at least one of the interior surface of the channel or the arm engagement region of the fastener is tapered to allow a longitudinal axis of the fastener to pivot within the channel to change an angle between the longitudinal axis of the fastener and a longitudinal axis of the arm.

22. The swing gate actuator assembly of claim 21 wherein the interior surface of the channel is tapered.

23. The swing gate actuator assembly of claim 22 wherein the interior surface of the channel includes a first tapered section, a second tapered section, and a pivot portion, and wherein the pivot portion is between the first tapered section and the second tapered section.

24. The swing gate actuator assembly of claim 23 wherein the pivot portion is in engagement with at least a portion of the arm engagement region, and wherein the first and second tapered sections are out of engagement with the fastener when the fastener is substantially perpendicular to a longitudinal axis of the distal portion of the arm.

25. The swing gate actuator assembly of claim 23 wherein, when the fastener is inserted through the channel, at least a portion of either the first tapered section nor the second tapered section is spaced apart from the fastener.

26. The swing gate actuator assembly of claim 25 wherein the arm can pivot about the pivot portion and the portion of either the first tapered section or the second tapered section spaced apart from the fastener to contact the fastener.
